(19) United States
(12) Patent Application Publication
(10) Pub. No.: US 2025/0381985 A1
(43) Pub. Date: Dec. 18, 2025

(54) TRAVEL ASSISTANCE DEVICE AND TRAVEL ASSISTANCE METHOD

(71) Applicants: Nissan Motor Co., Ltd., Kanagawa (JP); RENAULT S.A.S., Boulogne-Billancourt (FR)

(72) Inventors: Yoshitaka Takagi, Kanagawa (JP); Yutaka Mikuriya, Kanagawa (JP)

(73) Assignees: Nissan Motor Co., Ltd., Kanagawa (JP); RENAULT S.A.S., Boulogne-Billancourt (FR)

(21) Appl. No.: 18/835,898

(22) PCT Filed: Feb. 8, 2022
(86) PCT No.: PCT/IB2022/000069

§ 371 Date: Feb. 24, 2025

(51) Int. Cl. B60W 60/00; B60W 30/14; G06Q 50/47

(52) U.S. Cl. CPC B60W 60/0011; B60W 30/146; B60W 60/0021; B60W 60/00253; G06Q 50/47; B60W 2530/18; B60W 2540/215; B60W 2555/60; B60W 2720/10

(57) ABSTRACT

A travel assistance device configured to detect a surrounding environment of a first vehicle by an onboard sensor of the first vehicle and assist the autonomously traveling first vehicle in traveling includes at least one computer configured to perform processing including: setting allowable travel speed, that is a speed at which the first vehicle can be caused to travel under autonomous driving control, to a speed lower than a legal speed or a set speed, that is a speed set by a user, according to a recognition state of the onboard sensor or a vehicle state of the first vehicle; and generating an alternative route including a road having a speed limit less than or equal to the allowable travel speed as a target travel route of the first vehicle, based on the current position of the first vehicle, the destination of the first vehicle, and the allowable travel speed.

### TECHNICAL FIELD

The present invention relates to a travel assistance device and travel assistance method.

### BACKGROUND ART

In PTL 1 described below, a vehicle control device that limits target travel speed of a vehicle, based on precision of recognition of a surrounding situation based on output of an onboard sensor is described.

### CITATION LIST

### Patent Literature

PTL1: JP 2018-203017 A

### SUMMARY OF INVENTION

### Technical Problem

However, when limiting target travel speed of a vehicle causes travel speed of the vehicle to be lower than a speed limit of a road, there is a risk that traffic flow around the vehicle is obstructed and traffic efficiency deteriorates. An object of the present invention is to suppress deterioration of traffic efficiency caused by limiting target travel speed in autonomous driving control of a vehicle.

### Solution to Problem

According to an aspect of the present invention, there is provided a travel assistance device configured to detect a surrounding environment of a first vehicle by an onboard sensor of the first vehicle and assist the autonomously traveling first vehicle in traveling, based on the detected surrounding environment, the travel assistance device comprising at least one computer configured to perform processing including: acquiring position information about a current position of the first vehicle; acquiring position information about a destination of the first vehicle; setting allowable travel speed, the allowable travel speed being a speed at which the first vehicle can be caused to travel under autonomous driving control, to a speed lower than a legal speed or a set speed, the set speed being a speed set by a user, according to a recognition state of the onboard sensor or a vehicle state of the first vehicle; and generating an alternative route including a road having a speed limit less than or equal to the allowable travel speed as a target travel route of the first vehicle, based on the current position, the destination, and the allowable travel speed.

### Advantageous Effects of Invention

According to an aspect of the present invention, it is possible to suppress deterioration of traffic efficiency caused by limiting target travel speed in autonomous driving control of a vehicle.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

FIG. 1 is a schematic configuration diagram of an example of a vehicle dispatch system;

FIG. 2 is an explanatory diagram of an example of a travel assistance method of an embodiment;

FIG. 3 is a block diagram of an example of a functional configuration of a controller of an in-vehicle device;

FIG. 4 is a block diagram of an example of a functional configuration of a server device;

FIG. 5 is an explanatory diagram of an example of processing when no alternative route enabling a first vehicle to reach a destination can be generated;

FIG. 6 is a flowchart of an example of operation of the first vehicle;

FIG. 7 is a flowchart of an example of operation of the server device;

FIG. 8 is a sequence diagram of a first example of operation of the vehicle dispatch system;

FIG. 9 is a sequence diagram of a second example of the operation of the vehicle dispatch system; and

FIG. 10 is a sequence diagram of a third example of the operation of the vehicle dispatch system.

### DESCRIPTION OF EMBODIMENTS

### (Configuration)

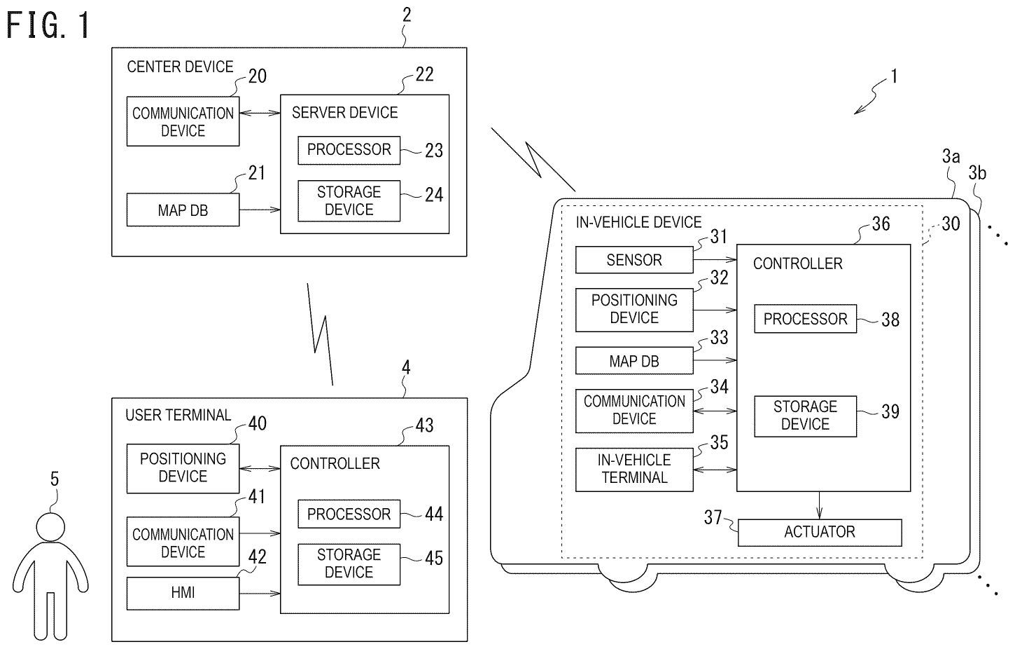

FIG. 1 is a schematic configuration diagram of an example of a vehicle dispatch system of an embodiment. A vehicle dispatch system 1 of the embodiment is a system that, in a transportation service that transports a passenger by operating an autonomous driving vehicle, dispatches an autonomous driving vehicle to be provided for the service. Herein, the autonomous driving vehicle to be provided for the transportation service is referred to as “service vehicle”. The vehicle dispatch system 1 is an example of a “travel assistance device” described in the claims. Hereinafter, the transportation service provided in the vehicle dispatch system 1 is simply referred to as “transportation service”.

The vehicle dispatch system 1 includes a center device 2, in-vehicle devices 30 each of which is mounted on one of a plurality of service vehicles including a first service vehicle 3a, a second service vehicle 3b, and so on, and a user terminal 4 that a passenger 5 carries. The first service vehicle 3a and the second service vehicle 3b are examples of a “first vehicle” and a “second vehicle” described in the claims, respectively. Hereinafter, the first service vehicle 3a, the second service vehicle 3b, and so on are sometimes collectively referred to as “service vehicles 3”.

Each of the service vehicles 3 is a vehicle that is operated in response to a request from the passenger 5 and is, for example, a shared taxi or a robot taxi. Each of the service vehicles 3 is an autonomous driving vehicle that is driven by a controller 36 in an automated manner without involvement of a driver (a human) in accordance with a target travel route sent from the center device 2. Each of the service vehicles 3 autonomously travels to a destination of the passenger 5, based on a detection result of a surrounding environment and a vehicle traveling state detected by sensors 31, a positioning result from a positioning device 32, and a map database (map DB) 33. That is, a subject that drives each of the service vehicles 3 is a control device that is capable of controlling travel of the vehicle.

The center device 2 includes a communication device 20, a map DB 21, and a server device 22. The communication device 20 provides a communication function between the server device 22 and an external device. A communication system used by the communication device 20 may be, for example, wired communication or wireless communication via a public mobile communication network, satellite communication, road-to-vehicle communication between the server device 22 and the in-vehicle device 30 of each of the service vehicles 3, or the like. The server device 22 transmits and receives data to and from the in-vehicle devices 30 and the user terminal 4 through the communication device 20.

In the map DB 21, map information of an area in which the transportation service is provided is stored. The map information includes road map data that can be used for route search for a travel route along which a service vehicle 3 travels from a point of departure to a destination. For example, the map information may include map data for navigation including road-by-road information. In addition, the map information includes speed limit information relating to a speed limit of each of roads included in the road map data. Further, the map information may include information about a point that can be specified as a boarding point on a service vehicle 3.

The server device 22 is an information processing device that performs processing including: receiving reservation information through which the passenger 5 requests dispatch of a service vehicle 3, from the user terminal 4; selecting a service vehicle 3 to be dispatched for the passenger 5; calculating a target travel route from a boarding point to a destination of the passenger 5; and providing the service vehicle 3 with the target travel route.

The server device 22 includes a processor 23 and a storage device 24. The processor 23 may be, for example, a CPU or an MPU. The storage device 24 may include a non-transitory physical storage medium like registers, a cache memory, and a memory or the like, such as a ROM and a RAM, that is used as a main storage device. Functions of the server device 22, which will be described below, are achieved by, for example, the processor 23 executing computer programs stored in the storage device 24.

The in-vehicle device 30 of each of the service vehicles 3 includes the sensors 31, the positioning device 32, the map DB 33, a communication device 34, an in-vehicle terminal 35, the controller 36, and actuators 37.

The sensors 31 include various onboard sensors that are mounted on the service vehicle 3. For example, the sensors 31 include object sensors configured to detect an object around the service vehicle 3 and vehicle sensors configured to detect a state of the service vehicle 3 (vehicle state).

The object sensors detect a surrounding environment of the service vehicle 3, such as a relative position between an object existing around the service vehicle 3 and the service vehicle 3, distance between the service vehicle 3 and the object, and a direction in which the object exists. The object sensors may include, for example, a camera to capture an image of the surrounding environment of the service vehicle 3. In addition, the object sensors may include, for example, a ranging device, such as a laser range finder (LRF), a radar, and a laser radar of a light detection and ranging (LiDAR). The object sensors output surrounding environment information that is information about the detected surrounding environment of the service vehicle 3, to the controller 36.

The vehicle sensors may include, for example, a vehicle speed sensor to detect travel speed (vehicle speed) of the service vehicle 3, wheel speed sensors to detect rotational speeds of respective tires that the service vehicle 3 includes, a triaxial acceleration sensor (G sensor) to detect acceleration (including deceleration) in three axial directions of the service vehicle 3, a steering angle sensor to detect a steering angle of a steering wheel, a gyro sensor to detect angular velocity generated in the service vehicle 3, and a yaw rate sensor to detect a yaw rate.

In addition, when the service vehicle 3 includes an electric motor as a drive source, the vehicle sensors may detect a state of charge (SOC) of a battery supplying the electric motor with power and battery temperature. The vehicle sensors output vehicle state information to the controller 36.

The positioning device 32 measures a current position and attitude of the service vehicle 3. The positioning device 32 may include, for example, a global navigation satellite system (GNSS) receiver. The GNSS receiver is, for example, a global positioning system (GPS) receiver or the like and, by receiving radio waves from a plurality of navigation satellites, measures a current position of the service vehicle 3. The positioning device 32 may include an inertial navigation device. The positioning device 32 outputs current position information that is information about measured current position and attitude, to the controller 36.

The map DB 33 stores map information. The map information stored in the map DB 33 is high-definition map data (hereinafter, simply referred to as “high-definition map”) that are suitable as map information for autonomous driving. The high-definition map is map data that have higher precision than the map data for navigation. Information about roads that the high-definition map has includes lane-by-lane information that is more detailed than road-by-road information.

The communication device 34 provides a communication function between the in-vehicle device 30 and an external device. A communication system used by the communication device 34 may be, for example, wireless communication via a public mobile communication network, satellite communication, road-to-vehicle communication, or the like. The in-vehicle device 30 transmits and receives data to and from the server device 22 of the center device 2 through the communication device 34. The in-vehicle terminal 35 is a terminal device that is used by the passenger 5 who boards the service vehicle 3. The in-vehicle terminal 35 may be an information terminal device separate from the controller 36 or a human-machine interface (HMI) integrated with the controller 36.

The controller 36 is an electronic control unit configured to control operation of the in-vehicle device 30. The controller 36 includes a processor 38 and peripheral components, such as a storage device 39. The processor 38 may be, for example, a CPU or an MPU. The storage device 39 may include a non-transitory physical storage medium like registers, a cache memory, and a memory or the like, such as a ROM and a RAM, that is used as a main storage device. Functions of the controller 36 are achieved by, for example, the processor 38 executing computer programs stored in the storage device 39.

The actuators 37 generate vehicle behavior of the service vehicle 3 by operating a steering device, a drive device, and a braking device of the service vehicle 3 in response to a control signal from the controller 36. The actuators 37 include a steering actuator, an accelerator opening actuator, and a brake control actuator.

The controller 36 receives a target travel route from the server device 22 via the communication device 34. The controller 36 calculates a target travel trajectory that causes the service vehicle 3 to travel along the target travel route, based on the current position and attitude of the service vehicle 3, the target travel route provided from the server device 22, the high-definition map, and the surrounding environment of the service vehicle 3. The controller 36 drives the actuators 37 in such a way that the service vehicle 3 travels along the generated target travel trajectory.

The user terminal 4 is carried by the passenger 5 and used when the passenger 5 uses the transportation service. The user terminal 4 includes a positioning device 40, a communication device 41, an HMI 42, and a controller 43.

The positioning device 40 measures a current position of the user terminal 4 (that is, a current position of the passenger 5). The positioning device 40 may include, for example, a global navigation satellite system receiver. The GNSS receiver may be, for example, a global positioning system receiver or the like.

The communication device 41 provides a communication function between the user terminal 4 and an external device. A communication system used by the communication device 41 may be, for example, wireless communication via a public mobile communication network, satellite communication, or the like. The user terminal 4 transmits and receives data to and from the server device 22 of the center device 2 through the communication device 41.

The HMI 42 is an interface device that transfers information between the user terminal 4 and the passenger 5.

The controller 43 is an electronic control unit configured to control operation of the user terminal 4. The controller 43 includes a processor 44 and peripheral components, such as a storage device 45. The processor 44 may be, for example, a CPU or an MPU. The storage device 45 may include a storage medium like registers, a cache memory, and a memory or the like, such as a ROM and a RAM, that is used as a main storage device.

Functions of the controller 43 are achieved by, for example, the processor 44 executing computer programs stored in the storage device 45. For example, the processor 44 accepts a reservation operation for the transportation service performed by the passenger 5, by executing dedicated application software to use the transportation service. For example, the passenger 5 inputs a boarding point at which the passenger 5 is to board a service vehicle 3 and information relating to a desired boarding time to the user terminal 4. The processor 44 transmits information that the passenger 5 inputs, to the server device 22 as reservation information. The passenger 5 may input the reservation information to a site that accepts a reservation for the transportation service on the Internet, using a browser function of the user terminal 4.

### (Outline of Operation of Vehicle Dispatch System)

Outline of operation of the service vehicles 3 performed by the vehicle dispatch system 1 will be described below. When the server device 22 receives reservation information from the user terminal 4, the server device 22 determines a service vehicle 3 to be provided for use by the passenger 5, based on a boarding point included in the reservation information and the current positions of the service vehicles 3. A case is now assumed where the first service vehicle 3a is selected. The server device 22 calculates a target travel route starting from the current position of the first service vehicle 3a and reaching the boarding point, based on the map information in the map DB 21. The server device 22 transmits information about the calculated target travel route to the first service vehicle 3a.

When the controller 36 of the first service vehicle 3a receives the information about the target travel route, the controller 36 causes the first service vehicle 3a to travel to the boarding point of the passenger 5 along the target travel route. When the passenger 5 boards the first service vehicle 3a at the boarding point, the vehicle dispatch system 1 accepts as input a destination of the passenger 5. For example, the passenger 5 may input the destination of the passenger 5 by operating the user terminal 4 that executes the dedicated application software. The user terminal 4 transmits information about the destination that the passenger 5 inputs, to the server device 22. The passenger 5 may input the destination of the passenger 5 by operating the in-vehicle terminal 35 of the first service vehicle 3a. In this case, the controller 36 transmits information about the destination to the server device 22.

The server device 22 calculates a target travel route starting from the current position of the first service vehicle 3a and reaching the destination, based on the map information in the map DB 21. The server device 22 transmits information about the calculated target travel route to the first service vehicle 3a.

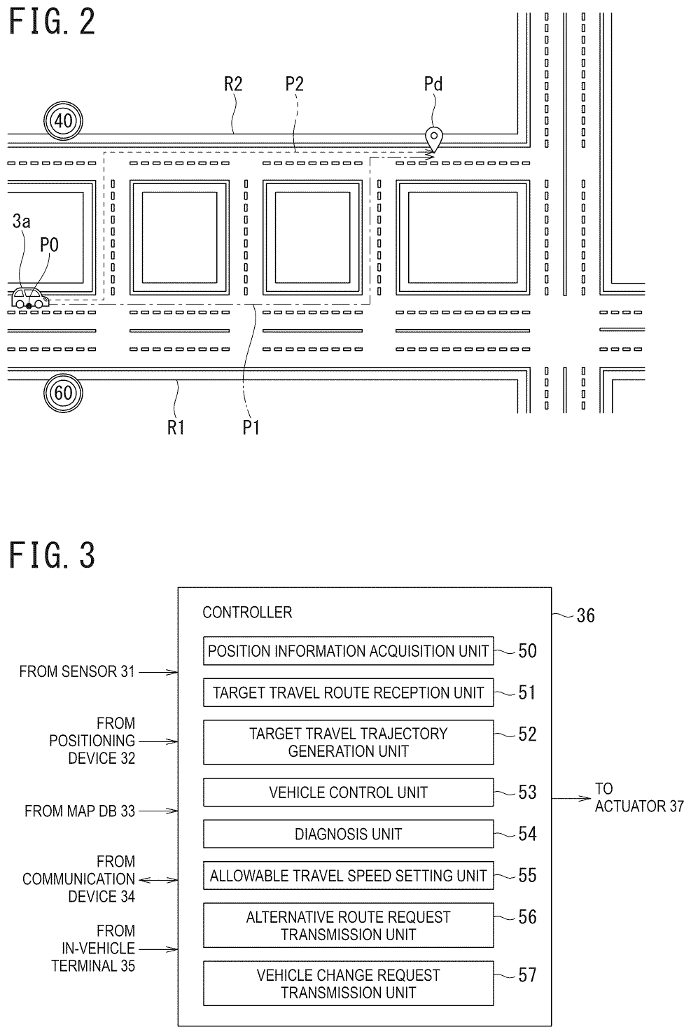

In FIG. 2, an example of a target travel route P1 is illustrated. The target travel route P1 is a route that travels along a road R1 having a speed limit of 60 km/h from a current position P0 of the first service vehicle 3a and subsequently changes course to a road R2 having a speed limit of 40 km/h immediately before a destination Pd and reaches the destination Pd. When the controller 36 of the first service vehicle 3a receives information about the target travel route, the controller 36 causes the first service vehicle 3a to travel to the destination Pd along the target travel route P1.

The controller 36 of the first service vehicle 3a sometimes limits travel speed of the first service vehicle 3a to a speed less than or equal to a speed limit according to a recognition state of the object sensors in the sensors 31 and a vehicle state of the first service vehicle 3a. For example, when automated vehicle stop control against an object in front of the vehicle is control that causes the first service vehicle 3a to decelerate at a deceleration of 0.1 G, which is a regularly-performed, comparatively-weak braking, the first service vehicle 3a that is traveling at 60 km/h is required to travel 140 m to come to a stop and the first service vehicle 3a that is traveling at 40 km/h is required to travel 70 m to come to a stop.

Therefore, when detection distance in front of the first service vehicle 3a at which the object sensors can recognize an object deteriorates from 140 m to 70 m, the controller 36 sets an allowable travel speed Va that is a speed at which the first service vehicle 3a can be caused to travel under autonomous driving control to, for example, 40 km/h and limits the travel speed of the first service vehicle 3a to a speed less than or equal to the allowable travel speed Va.

As a result, when the first service vehicle 3a continues to travel on the road R1 having a speed limit of 60 km/h along the target travel route P1, there is a risk that travel of other vehicles around the first service vehicle 3a is disturbed and traffic efficiency on the road R1 deteriorates.

Thus, the server device 22 provides the first service vehicle 3a with an alternative route P2 that includes a road having a speed limit less than or equal to the allowable travel speed Va, as a target travel route. For example, the server device 22 generates the alternative route P2 in such a way that a ratio of distance that the first service vehicle 3a travels on the road R2 having a speed limit less than or equal to the allowable travel speed Va is higher than the original target travel route P1.

Since because of this configuration, distance that the first service vehicle 3a travels at a speed lower than the speed limit can be reduced, it is possible to make the first service vehicle 3a less likely to prevent travel of another vehicle around the first service vehicle 3a. Because of this capability, it is possible to suppress the first service vehicle 3a from obstructing traffic flow around the first service vehicle 3a and causing traffic efficiency to deteriorate.

Next, a functional configuration of each unit in the vehicle dispatch system 1 will be described. FIG. 3 is a block diagram of an example of a functional configuration of the controller 36 of the in-vehicle device 30 of the first service vehicle 3a. The controllers 36 of other service vehicles 3 (for example, the second service vehicle 3b) may have the same functional configuration. The controller 36 includes a position information acquisition unit 50, a target travel route reception unit 51, a target travel trajectory generation unit 52, a vehicle control unit 53, a diagnosis unit 54, an allowable travel speed setting unit 55, an alternative route request transmission unit 56, and a vehicle change request transmission unit 57.

The position information acquisition unit 50 acquires position information about a current position of the first service vehicle 3a, based on a measurement result of the positioning device 32. The target travel route reception unit 51 receives a target travel route from the server device 22 via the communication device 34. The target travel trajectory generation unit 52 calculates a target travel trajectory that causes the first service vehicle 3a to travel along the target travel route, based on the current position and attitude of the first service vehicle 3a, the target travel route provided from the server device 22, the high-definition map, and the surrounding environment of the first service vehicle 3a. For example, the target travel trajectory generation unit 52 generates a route space map that represents existence or nonexistence of a route and an object around the first service vehicle 3a and a risk map obtained by quantifying a degree of risk in a traveling field and generates a target travel trajectory that causes the first service vehicle 3a to travel, based on motion characteristics of the first service vehicle 3a, vehicle information, the route space map, and the risk map.

The vehicle control unit 53 controls the actuators 37 in such a way that the first service vehicle 3a travels along the generated target travel trajectory.

The diagnosis unit 54 diagnoses a recognition state of the object sensors in the sensors 31 and a vehicle state of the first service vehicle 3a. For example, the diagnosis unit 54 may diagnose recognition performance of the object sensors in recognizing an environment in front of the first service vehicle 3a. For example, the diagnosis unit 54 may diagnose detection distance at which the object sensors can detect an environment in front of the first service vehicle 3a. For example, the diagnosis unit 54 may estimate sunshine and weather at the current position by acquiring weather information from an external server device via the communication device 34 and diagnose recognition performance of the object sensors, based on the estimated sunshine and weather. In addition, for example, the diagnosis unit 54 may estimate sunshine at the current position of the first service vehicle 3a, based on calendar information and time information and diagnose the recognition performance of the object sensors, based on the estimated sunshine. In addition, for example, the diagnosis unit 54 may determine a time period, based on the time information and diagnose the recognition performance of the object sensors, based on the time period. In addition, for example, the diagnosis unit 54 may diagnose the recognition performance of the object sensors, based on whether or not the object sensors have malfunctioned. In addition, for example, the diagnosis unit 54 diagnoses a vehicle state of the first service vehicle 3a, based on output signals from the vehicle sensors in the sensors 31. When the service vehicle 3 includes an electric motor as a drive source, the vehicle sensors may detect an SOC of a battery supplying the electric motor with power and battery temperature.

The allowable travel speed setting unit 55 sets the allowable travel speed Va to a speed lower than a speed set by a user or a legal speed (hereinafter, referred to as “set speed Vs”), based on a diagnosis result of the diagnosis unit 54. For example, when the recognition performance of the object sensors in recognizing an environment in front of the first service vehicle 3a deteriorates, the allowable travel speed setting unit 55 sets the allowable travel speed Va to a speed lower than the set speed Vs. For example, the allowable travel speed setting unit 55 may calculate the allowable travel speed Va, based on the detection distance at which the object sensors can detect an environment in front of the first service vehicle 3a. For example, the allowable travel speed setting unit 55 may calculate the allowable travel speed Va that becomes slower as the detection distance of the object sensors becomes shorter. In addition, for example, when an object sensor has malfunctioned, the allowable travel speed setting unit 55 may set the allowable travel speed Va to a speed less than or equal to a slowest speed (for example, 10 km/h).

The allowable travel speed setting unit 55 may set the allowable travel speed Va to a speed lower than the set speed Vs when regenerative control cannot be performed since the SOC of the battery is higher than a threshold value or when the battery temperature is higher than a threshold value.

Note that when the allowable travel speed setting unit 55 sets an allowable travel speed Va lower than the set speed Vs, the allowable travel speed setting unit 55 may set the allowable travel speed Va to a lower speed when no passenger 5 is on board the first service vehicle 3a than when a passenger 5 is on board the first service vehicle 3a.

When the allowable travel speed Va is set to a speed lower than the set speed Vs, the alternative route request transmission unit 56 transmits an alternative route request signal requesting provision of an alternative route P2, to the server device 22. For example, the alternative route request transmission unit 56 may transmit an alternative route request signal to the server device 22 when the allowable travel speed Va is a speed lower than the set speed Vs and greater than or equal to a threshold value Vt. The alternative route request signal includes position information about the current position P0 of the first service vehicle 3a and information about the allowable travel speed Va.

In addition, the alternative route request transmission unit 56 may acquire information about delay time of the transportation service that the passenger 5 can tolerate (hereinafter, referred to as “margin time Tm”) when the allowable travel speed Va is set to a speed lower than the set speed Vs. The margin time Tm is delay time that the passenger 5 can tolerate when arrival of the passenger 5 using the transportation service at the destination Pd is delayed.

For example, the alternative route request transmission unit 56 may acquire information about the margin time Tm that the passenger 5 inputs using the in-vehicle terminal 35. In this case, the alternative route request transmission unit 56 transmits the information about the margin time Tm to the server device 22. The information about the margin time Tm may be input by the passenger 5 to the in-vehicle terminal 35 or the user terminal 4 when the passenger 5 boards the first service vehicle 3a or may be input to the user terminal 4 when the passenger 5 makes a reservation for the transportation service and transmitted to the server device 22 from the user terminal 4.

The server device 22 generates an alternative route P2 in response to the alternative route request signal and transmits the alternative route P2 to the first service vehicle 3a as a target travel trajectory of the first service vehicle 3a. In the first service vehicle 3a, the target travel route reception unit 51 receives the alternative route P2. The target travel trajectory generation unit 52 calculates a target travel trajectory that causes the first service vehicle 3a to travel along the alternative route P2. The vehicle control unit 53, while limiting the travel speed of the first service vehicle 3a to a speed less than or equal to the allowable travel speed Va by causing the first service vehicle 3a to decelerate, controls the actuators 37 in such a way that the first service vehicle 3a travels along the generated target travel trajectory.

On the other hand, when the allowable travel speed Va is a speed less than the threshold value Vt, the vehicle control unit 53 causes the first service vehicle 3a to decelerate and stop at a point at which the passenger 5 can safely get off the first service vehicle 3a. For example, when the allowable travel speed Va is set to a speed less than or equal to the slowest speed (for example, 10 km/h), the vehicle control unit 53 may cause the first service vehicle 3a to decelerate and stop. The vehicle change request transmission unit 57 transmits a vehicle change request signal requesting dispatch of another service vehicle 3 that transports the passenger 5 to the destination Pd in place of the first service vehicle 3a, to the server device 22. The vehicle change request signal includes information about a position at which the first service vehicle 3a has stopped (stop position).

The server device 22 selects another service vehicle 3 that transports the passenger 5 in place of the first service vehicle 3a, in response to the vehicle change request signal. A case is now assumed where the second service vehicle 3b is selected. The server device 22 calculates a target travel route starting from a current position of the second service vehicle 3b and reaching the stop position of the first service vehicle 3a and a remaining travel route Pr starting from the stop position of the first service vehicle 3a and reaching the destination Pd, based on the map information in the map DB 21. The server device 22 transmits information about the above-described target travel routes to the second service vehicle 3b.

When the controller 36 of the second service vehicle 3b receives the information about the target travel routes, the controller 36 causes the second service vehicle 3b to travel to the stop position of the first service vehicle 3a along the target travel route. When the passenger 5 boards the second service vehicle 3b, the controller 36 of the second service vehicle 3b causes the second service vehicle 3b to travel to the destination Pd along the remaining travel route Pr.

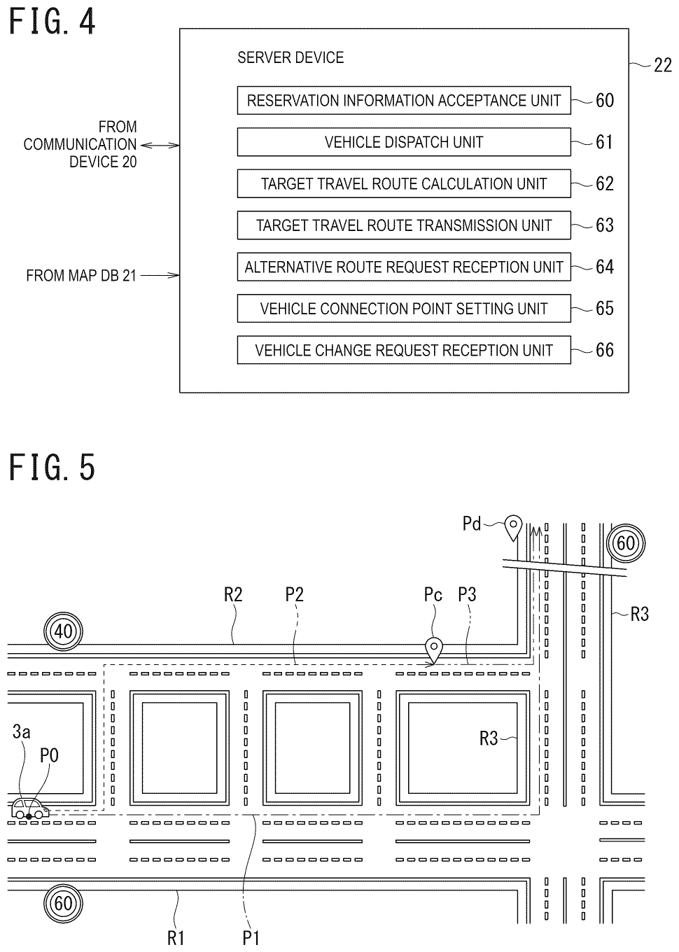

FIG. 4 is a block diagram of an example of a functional configuration of the server device 22. The server device 22 includes a reservation information acceptance unit 60, a vehicle dispatch unit 61, a target travel route calculation unit 62, a target travel route transmission unit 63, an alternative route request reception unit 64, a vehicle connection point setting unit 65, a vehicle change request reception unit 66.

The reservation information acceptance unit 60 receives reservation information from the user terminal 4. The vehicle dispatch unit 61 determines a service vehicle 3 to be provided for use by the passenger 5, based on a boarding point included in the reservation information and the current positions of the service vehicles 3. For example, the vehicle dispatch unit 61 selects a service vehicle 3 that is not currently used (that is, can be dispatched) and is closest to the boarding point. A case is now assumed where the first service vehicle 3a is selected.

The target travel route calculation unit 62 calculates a target travel route starting from the current position of the first service vehicle 3a and reaching the boarding point, based on the map information in the map DB 21. For example, the target travel route calculation unit 62 calculates a target travel route, based on a known route search algorithm, such as Dijkstra's algorithm. In addition, when the passenger 5 boards the first service vehicle 3a and the target travel route calculation unit 62 receives information about the destination Pd from the controller 36, the target travel route calculation unit 62 calculates a target travel route P1 starting from the current position P0 of the first service vehicle 3a and reaching the destination Pd. The target travel route transmission unit 63 transmits information about the calculated target travel route P1 to the first service vehicle 3a.

The alternative route request reception unit 64 receives an alternative route request signal transmitted from the controller 36 of the first service vehicle 3a. When the alternative route request reception unit 64 receives an alternative route request signal, the target travel route calculation unit 62 generates an alternative route P2 starting from the current position P0 of the first service vehicle 3a and reaching the destination Pd in such a way that the alternative route P2 includes the road R2 having a speed limit less than or equal to the allowable travel speed Va, based on the map information in the map DB 21, the information about the destination Pd, position information about the current position P0 of the first service vehicle 3a and the information about the allowable travel speed Va that are included in the alternative route request signal. The target travel route transmission unit 63 transmits information about the generated alternative route P2 to the first service vehicle 3a.

For example, the target travel route calculation unit 62 may generate the alternative route P2 in such a way that a ratio of distance that the first service vehicle 3a travels on the road R2 having a speed limit less than or equal to the allowable travel speed Va is higher when the allowable travel speed Va is set to a speed lower than the set speed Vs than when the allowable travel speed Va is not set to a speed lower than the set speed Vs. For example, the target travel route calculation unit 62 may attempt to generate the alternative route P2 in such a way that the first service vehicle 3a travels only on a road having a speed limit less than or equal to the allowable travel speed Va from the current position and reaches the destination Pd.

The target travel route calculation unit 62 may generate an alternative route P2 including a road having a speed limit less than or equal to the allowable travel speed Va and having a highest speed limit. In addition, for example, the target travel route calculation unit 62 may estimate an arrival time T1 at which the first service vehicle 3a arrives at the destination Pd when it is assumed that the allowable travel speed Va is not set to a speed lower than the set speed Vs and the first service vehicle 3a travels along the original target travel route P1 and an arrival time T2 at which the first service vehicle 3a arrives at the destination Pd when the allowable travel speed Va is set to a speed lower than the set speed Vs and the first service vehicle 3a travels along the alternative route P2, generate candidates of the alternative route P2 that cause delay time of the arrival time T2 with respect to the arrival time T1 to be less than or equal to the margin time Tm, and select an alternative route P2 to be used as a target travel trajectory for the first service vehicle 3a from among the candidates.

FIG. 5 illustrates an example of a situation in which a speed limit (60 km/h) of a road R3 is higher than the allowable travel speed Va and the first service vehicle 3a is required to travel a certain distance on the road R3 in order to reach the destination Pd. In such a situation, it is sometimes difficult to generate an alternative route that is capable of effectively suppressing the first service vehicle 3a from obstructing traffic flow on a road having a speed limit higher than the allowable travel speed Va.

In such a case, the server device 22 sets a vehicle connection point Pc at which the passenger 5 of the first service vehicle 3a transfers to another service vehicle 3 and transports the passenger 5 by operating the another service vehicle 3 from the vehicle connection point Pc to the destination Pd.

The vehicle connection point setting unit 65 determines whether or not an alternative route that is capable of effectively suppressing the first service vehicle 3a from obstructing traffic flow on a road having a speed limit higher than the allowable travel speed Va can be generated. For example, when a ratio of distance that the first service vehicle 3a travels on a road having a speed limit less than or equal to the allowable travel speed Va is lower than a threshold value, the vehicle connection point setting unit 65 may determine that no alternative route that is capable of effectively suppressing obstruction of traffic flow can be generated. In addition, for example, when distance that the first service vehicle 3a travels on a road having a speed limit higher than the allowable travel speed Va is longer than a threshold value, the vehicle connection point setting unit 65 may determine that no alternative route that is capable of effectively suppressing obstruction of traffic flow can be generated. In addition, for example, when no alternative route along which the first service vehicle 3a can reach the destination Pd by traveling on a road having a speed limit less than or equal to the allowable travel speed Va and can be generated, the vehicle connection point setting unit 65 may determine that no alternative route that is capable of effectively suppressing obstruction of traffic flow can be generated.

When no alternative route that is capable of effectively suppressing traffic flow on a road having a speed limit higher than the allowable travel speed Va from being obstructed can be generated, the vehicle connection point setting unit 65 sets a vehicle connection point Pc. For example, the vehicle connection point setting unit 65 sets any point within an area in which the first service vehicle 3a can reach from the current position P0 by traveling on a road having a speed limit less than or equal to the allowable travel speed Va, as a vehicle connection point Pc. For example, the vehicle connection point setting unit 65 sets any point that the first service vehicle 3a can reach by traveling a distance less than or equal to a threshold value on a road having a speed limit higher than the allowable travel speed Va, as a vehicle connection point Pc.

In addition, for example, the vehicle connection point setting unit 65 may select a candidate (hereinafter, sometimes referred to as “alternative vehicle candidate”) of another service vehicle 3 that can be dispatched for the passenger 5 in place of the first service vehicle 3a, set a candidate (hereinafter, sometimes referred to as “vehicle connection point candidate”) of a point at which the passenger 5 of the first service vehicle 3a transfers to the alternative vehicle candidate, and set a vehicle connection point candidate that, when the passenger 5 changes the first service vehicle 3a to the alternative vehicle candidate at the vehicle connection point candidate, minimizes delay in an arrival time at which the alternative vehicle candidate arrives at the destination Pd, as a vehicle connection point Pc.

When the vehicle connection point Pc is set, the vehicle dispatch unit 61 selects a service vehicle 3 that transports the passenger 5 to the destination in place of the first service vehicle 3a from among other service vehicles 3 that can be dispatched. For example, the vehicle dispatch unit 61 calculates an arrival time T2 at which a service vehicle 3 arrives at the destination Pd when the service vehicle 3 travels from the current position of the service vehicle 3 to the vehicle connection point Pc and, after a passenger boards the service vehicle 3 at the vehicle connection point Pc, travels to the destination Pd. The vehicle dispatch unit 61 selects a service vehicle 3 that causes delay time of the arrival time T2 with respect to the arrival time T1 at which the service vehicle 3 arrives at the destination Pd when it is assumed that the allowable travel speed Va is not set to a speed lower than the set speed Vs and the service vehicle 3 travels along the original target travel route P1 to be less than or equal to the margin time Tm. A case is now assumed where the second service vehicle 3b is selected.

The target travel route calculation unit 62 calculates a travel route from the current position P0 of the first service vehicle 3a to the vehicle connection point Pc as the alternative route P2. The target travel route transmission unit 63 transmits information about the alternative route P2 to the first service vehicle 3a as a target travel route of the first service vehicle 3a.

On the other hand, the target travel route calculation unit 62 calculates a travel route from the current position of the second service vehicle 3b to the vehicle connection point Pc and also calculates a travel route from the vehicle connection point Pc to the destination Pd as an alternative route P3. The target travel route transmission unit 63 transmits information about the calculated travel routes to the second service vehicle 3b as target travel routes of the second service vehicle 3b.

The vehicle change request reception unit 66 receives a vehicle change request signal that the controller 36 of the first service vehicle 3a transmits. When the vehicle change request reception unit 66 receives the vehicle change request signal, the vehicle dispatch unit 61 selects a substitute service vehicle 3 to be provided for use by the passenger 5, in response to the vehicle change request signal. A case is now assumed where the second service vehicle 3b is selected. The target travel route calculation unit 62 calculates a target travel route starting from the current position of the second service vehicle 3b and reaching the stop position of the first service vehicle 3a and a remaining travel route Pr starting from the stop position of the first service vehicle 3a and reaching the destination Pd, based on the map information in the map DB 21. The target travel route transmission unit 63 transmits information about the above-described travel routes to the second service vehicle 3b.

### (Operation)

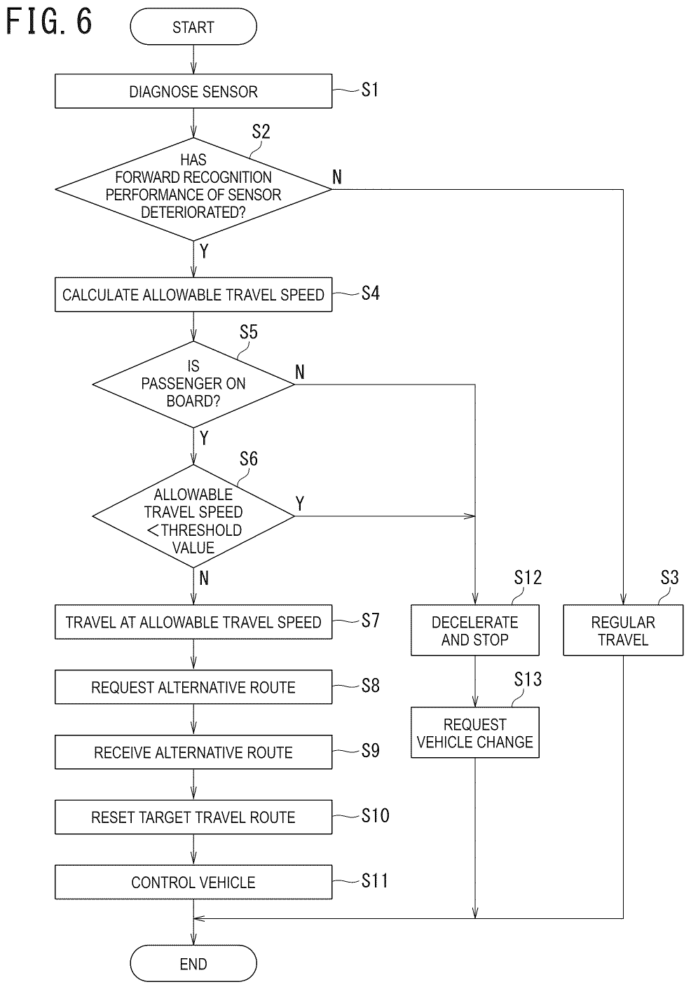

FIG. 6 is a flowchart of an example of operation of the first service vehicle 3a.

In step S1, the diagnosis unit 54 diagnoses a recognition state of the object sensors in the sensors 31.

In step S2, the diagnosis unit 54 determines whether or not forward recognition performance of the object sensors has deteriorated. When the forward recognition performance has deteriorated (step S2: Y), the process proceeds to step S4. When the forward recognition performance has not deteriorated (step S2: N), the process proceeds to step S3. In step S3, the vehicle control unit 53 causes the first service vehicle 3a to travel in a regular manner. Subsequently, the process terminates.

In step S4, the allowable travel speed setting unit 55 sets the allowable travel speed Va to a speed lower than the set speed Vs.

In step S5, the vehicle change request transmission unit 57 determines whether or not a passenger 5 is on board the first service vehicle 3a. When a passenger 5 is on board (step S5: Y), the process proceeds to step S6. When no passenger 5 is on board (step S5: N), the process proceeds to step S12.

In step S6, the vehicle change request transmission unit 57 determines whether or not the allowable travel speed Va is less than a threshold value Vt. When the allowable travel speed Va is less than the threshold value Vt (step S6: Y), the process proceeds to step S12. When the allowable travel speed Va is not less than the threshold value Vt (step S6: N), the process proceeds to step S7.

In step S7, the vehicle control unit 53 limits travel speed of the first service vehicle 3a to a speed less than or equal to the allowable travel speed Va by causing the first service vehicle 3a to decelerate.

In step S8, the alternative route request transmission unit 56 transmits an alternative route request signal to the server device 22. In step S9, the target travel route reception unit 51 receives an alternative route P2 from the server device 22.

In step S10, the target travel trajectory generation unit 52 resets the received alternative route P2 as a target travel route of the first service vehicle 3a and calculates a target travel trajectory that causes the first service vehicle 3a to travel along the alternative route P2.

In step S11, the vehicle control unit 53 controls the actuators 37 in such a way that the first service vehicle 3a travels along the generated target travel trajectory. Subsequently, the process terminates.

On the other hand, in step S12, the vehicle control unit 53 causes the first service vehicle 3a to decelerate and stop on a road shoulder at a point at which the passenger 5 can safely get off the first service vehicle 3a.

In step S13, the vehicle change request transmission unit 57 transmits a vehicle change request signal to the server device 22. Subsequently, the process terminates.

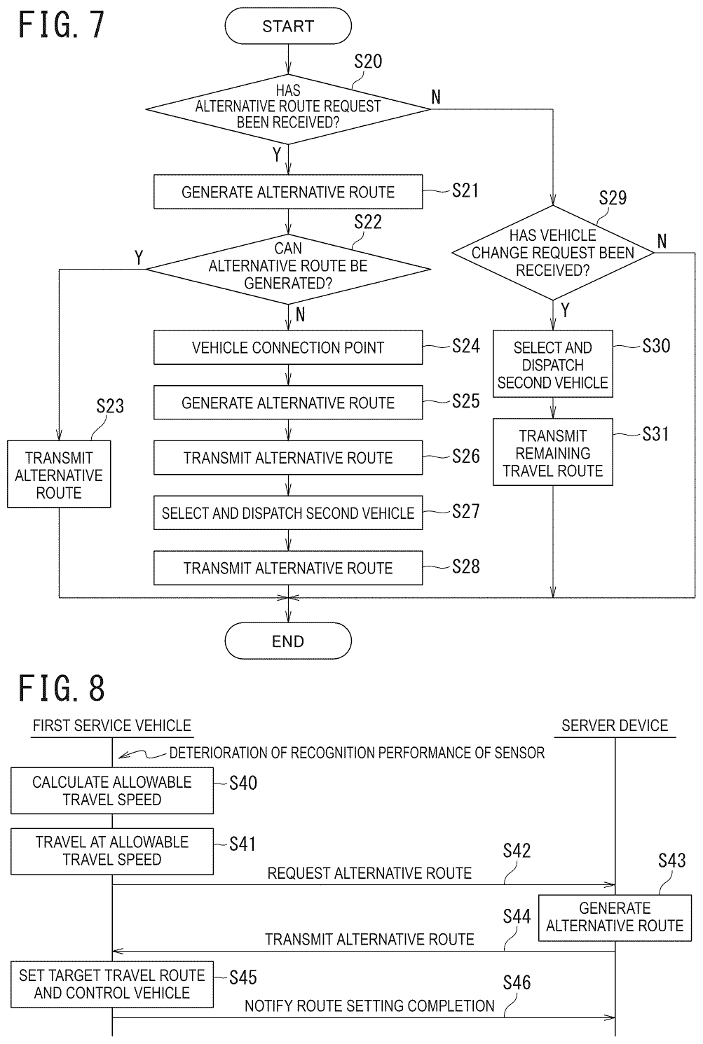

FIG. 7 is a flowchart of an example of operation of the server device 22. In step S20, the alternative route request reception unit 64 determines whether or not the alternative route request reception unit 64 has received an alternative route request signal. When the alternative route request reception unit 64 has received an alternative route request signal (step S20: Y), the process proceeds to step S21. When the alternative route request reception unit 64 has not received an alternative route request signal (step S20: N), the process proceeds to step S29.

In step S21, the target travel route calculation unit 62 attempts to generate an alternative route P2 along which the first service vehicle 3a travels on a road having a speed limit less than or equal to the allowable travel speed Va from a current position P0 of the first service vehicle 3a and reaches the destination Pd. When the target travel route calculation unit 62 can generate an alternative route P2 (step S22: Y), the process proceeds to step S23. When the target travel route calculation unit 62 cannot generate an alternative route P2 (step S22: N), the process proceeds to step S24.

In step S23, the target travel route transmission unit 63 transmits information about the generated alternative route P2 to the first service vehicle 3a. Subsequently, the process terminates.

In step S24, the vehicle connection point setting unit 65 sets a vehicle connection point Pc.

In step S25, the target travel route calculation unit 62 calculates a travel route from the current position P0 of the first service vehicle 3a to the vehicle connection point Pc as an alternative route P2. In addition, the target travel route calculation unit 62 calculates a travel route from the vehicle connection point Pc to the destination Pd as an alternative route P3. In step S26, the target travel route transmission unit 63 transmits information about the alternative route P2 to the first service vehicle 3a as a target travel route of the first service vehicle 3a.

In step S27, the vehicle dispatch unit 61 selects a second service vehicle 3b that transports the passenger 5 to the destination in place of the first service vehicle 3a. In step S28, the target travel route transmission unit 63 transmits information about the alternative route P3 to the second service vehicle 3b as a target travel route of the second service vehicle 3b. Subsequently, the process terminates.

In step S29, the vehicle change request reception unit 66 determines whether or not the vehicle change request reception unit 66 has received a vehicle change request signal. When the vehicle change request reception unit 66 has received a vehicle change request signal (step S29: Y), the process proceeds to step S30. When the vehicle change request reception unit 66 has not received a vehicle change request signal (step S29: N), the process terminates.

In step S30, the vehicle dispatch unit 61 selects a second service vehicle 3b that transports the passenger 5 to the destination in place of the first service vehicle 3a.

In step S31, the target travel route calculation unit 62 calculates a remaining travel route Pr starting from the stop position of the first service vehicle 3a and reaching the destination Pd. The target travel route transmission unit 63 transmits information about the remaining travel route Pr to the second service vehicle 3b. Subsequently, the process terminates.

FIG. 8 is a sequence diagram of a first example of operation of the vehicle dispatch system 1. When the forward recognition performance of the object sensors of the first service vehicle 3a deteriorates, the controller 36 of the first service vehicle 3a sets the allowable travel speed Va to a speed lower than the set speed Vs in step S40. When the allowable travel speed Va is greater than or equal to the threshold value Vt or the passenger 5 is on board the first service vehicle 3a, the controller 36 limits travel speed to the allowable travel speed Va in step S41. In step S42, the controller 36 transmits an alternative route request signal to the server device 22.

In step S43, the server device 22 attempts to generate an alternative route P2 along which the first service vehicle 3a travels on a road having a speed limit less than or equal to the allowable travel speed Va from the current position P0 of the first service vehicle 3a and reaches the destination Pd.

When the server device 22 can generate an alternative route P2, the server device 22 transmits information about the generated alternative route P2 to the first service vehicle 3a in step S44.

In step S45, the controller 36 resets the received alternative route P2 as a target travel route of the first service vehicle 3a and controls the first service vehicle 3a in such a way that the first service vehicle 3a travels along the alternative route P2. In step S46, the controller 36 transmits a route setting completion notification notifying that the controller 36 has set the alternative route P2 as a target travel route, to the server device 22.

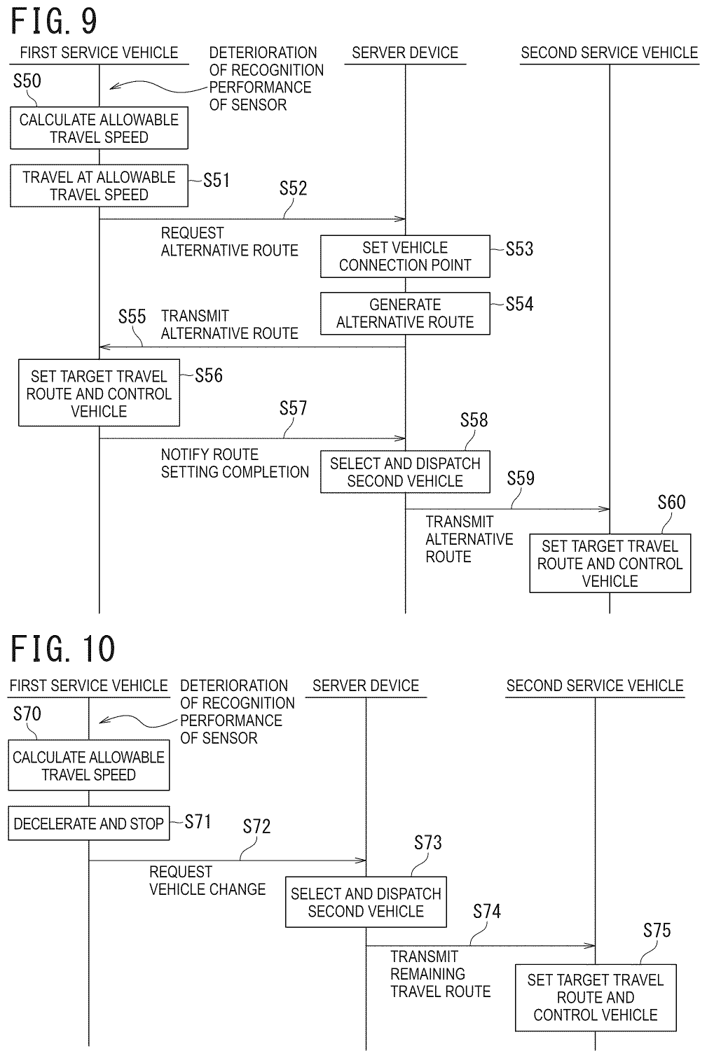

FIG. 9 is a sequence diagram of a second example of the operation of the vehicle dispatch system 1. Operations in steps S50 to S52 are the same as the operations in steps S40 to S42 in FIG. 8. In step S53, the server device 22 attempts to generate an alternative route P2 along which the first service vehicle 3a travels on a road having a speed limit less than or equal to the allowable travel speed Va from the current position P0 of the first service vehicle 3a and reaches the destination Pd. When the server device 22 cannot generate an alternative route P2, the server device 22 sets a vehicle connection point Pc at which the passenger 5 transfers to another service vehicle 3 from the first service vehicle 3a.

In step S54, the server device 22 calculates a travel route from the current position P0 of the first service vehicle 3a to the vehicle connection point Pc as an alternative route P2. In addition, the server device 22 calculates a travel route from the vehicle connection point Pc to the destination Pd as an alternative route P3.

In step S55, the server device 22 transmits information about the alternative route P2 to the first service vehicle 3a. Operations in steps S56 and S57 are the same as the operations in steps S45 and S46 in FIG. 8.

In step S58, the server device 22 selects a second service vehicle 3b that transports the passenger 5 to the destination in place of the first service vehicle 3a. In step S59, the server device 22 transmits information about the alternative route P3 to the second service vehicle 3b.

In step S60, the controller 36 of the second service vehicle 3b resets the received alternative route P3 as a target travel route of the second service vehicle 3b and controls the second service vehicle 3b in such a way that the second service vehicle 3b travels along the alternative route P3.

FIG. 10 is a sequence diagram of a third example of the operation of the vehicle dispatch system. When the forward recognition performance of the object sensors of the first service vehicle 3a deteriorates, the controller 36 of the first service vehicle 3a sets the allowable travel speed Va to a speed lower than the set speed Vs in step S70.

when the allowable travel speed Va is a speed less than the threshold value Vt or no passenger 5 is on board the first service vehicle 3a, the controller 36 causes the first service vehicle 3a to decelerate and stop at a point at which the passenger 5 can safely get off the first service vehicle 3a in step S71. In step S72, the controller 36 transmits a vehicle change request signal to the server device 22.

In step S73, the server device 22 selects a second service vehicle 3b that transports the passenger 5 to the destination in place of the first service vehicle 3a. In step S74, the server device 22 calculates a remaining travel route Pr starting from the stop position of the first service vehicle 3a and reaching the destination Pd and transmits information about the remaining travel route Pr to the second service vehicle 3b.

In step S75, the controller of the second service vehicle 3b resets the received remaining travel route Pr as a target travel route of the second service vehicle 3b and controls the second service vehicle 3b in such a way that the second service vehicle 3b travels along the remaining travel route Pr.

Although an example of the vehicle dispatch system 1 of the embodiment is described above, the vehicle dispatch system 1 may be configured such that the controller 36 of the first service vehicle 3a performs a portion of the processing performed by the above-described server device 22. In addition, although the above-described vehicle dispatch system 1 is a system based on a server-client model that includes the server device 22 and a plurality of service vehicles 3, the vehicle dispatch system 1 may be configured as a system based on a peer-to-peer model in which no server device 22 is included. That is, all the processing of the above-described server device 22 may be performed by the controller 36 of the first service vehicle 3a.

### (Advantageous Effects of Embodiment)

(1) A travel assistance device configured to detect a surrounding environment of a first vehicle by an onboard sensor of the first vehicle and assist the autonomously traveling first vehicle in traveling, based on the detected surrounding environment includes at least one computer configured to perform processing including: acquiring position information about a current position of the first vehicle; acquiring position information about a destination of the first vehicle; setting allowable travel speed, the allowable travel speed being a speed at which the first vehicle can be caused to travel under autonomous driving control, to a speed lower than a legal speed or a set speed, the set speed being a speed set by a user, according to a recognition state of the onboard sensor or a vehicle state of the first vehicle; and generating an alternative route including a road having a speed limit less than or equal to the allowable travel speed as a target travel route of the first vehicle, based on the current position, the destination, and the allowable travel speed.

For example, the at least one computer may generate the alternative route in such a way that a ratio of distance traveled by the first vehicle on a road having a speed limit less than or equal to the allowable travel speed is higher when the allowable travel speed is set to a speed lower than the set speed than when the allowable travel speed is not set to a speed lower than the set speed. In addition, for example, the at least one computer may generate the alternative route in such a way that the first vehicle travels only on a road having a speed limit less than or equal to the allowable travel speed from the current position and reaches the destination. In addition, for example, the at least one computer may generate the alternative route including a road having a speed limit less than or equal to the allowable travel speed and having a highest speed limit.

Because of this configuration, it is possible to suppress the first vehicle from obstructing traffic flow around the first vehicle and causing traffic efficiency to deteriorate. Since obstruction of traffic flow is suppressed, safety of traffic around the first vehicle can be improved through, for example, reduction in the number of lane changes performed by other vehicles that pass the first vehicle.

(2) The at least one computer may acquire information about margin time, the margin time being delay time of an arrival time at the destination tolerated by a passenger of the first vehicle, and generate a candidate of the alternative route within a range of the margin time. Because of this configuration, an alternative route that enables the first vehicle to arrive at the destination within a range of delay time that the passenger tolerates can be generated.

(3) When the at least one computer cannot generate the alternative route enabling the first vehicle to reach the destination from the current position, the at least one computer may set a vehicle connection point at which a passenger of the first vehicle transfers to another second vehicle within an area in which the first vehicle can arrive by traveling on a road having a speed limit less than or equal to the allowable travel speed. The at least one computer may dispatch an autonomous driving vehicle as the second vehicle. It is possible to, while suppressing the first vehicle from obstructing traffic flow around the first vehicle and causing traffic efficiency to deteriorate, transport the passenger to the destination.

(4) The at least one computer may acquire information about margin time, the margin time being delay time of an arrival time at the destination tolerated by a passenger of the first vehicle, and select a second vehicle from among candidates of an autonomous driving vehicle capable of arriving at the destination within a range of the margin time. Because of this configuration, a second vehicle that can transport the passenger to the destination within a range of delay time that the passenger tolerates can be selected.

(5) When the set allowable travel speed is less than a threshold value, the at least one computer may cause the first vehicle to stop. Because of this configuration, it is possible to suppress the first vehicle from obstructing traffic flow around the first vehicle and causing traffic efficiency to deteriorate.

(6) The at least one computer may set the allowable travel speed to a lower speed when no passenger is on board the first vehicle than when a passenger is on board the first vehicle. Because of this configuration, it is possible to operate the first vehicle more safely.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

### REFERENCE SIGNS LIST

1 Vehicle dispatch system
2 Center device
3a First service vehicle
3b Second service vehicle
22 Server device
23 Processor
24 Storage device
30 In-vehicle device
31 Sensor
36 Controller
37 Actuator
38 Processor
39 Storage device

1. A travel assistance device configured to detect a surrounding environment of a first vehicle by an onboard sensor of the first vehicle and assist the autonomously traveling first vehicle in traveling, based on the detected surrounding environment, the travel assistance device comprising at least one computer configured to perform processing comprising:
acquiring position information about a current position of the first vehicle;
acquiring position information about a destination of the first vehicle;
generating a first target travel route from the current position to the destination;
setting allowable travel speed, the allowable travel speed being a speed at which the first vehicle can be caused to travel under autonomous driving control, to a speed lower than a legal speed or a set speed, the set speed being a speed set by a user, according to a recognition state of the onboard sensor or a vehicle state of the first vehicle; and
generating a second target travel route from the current position to the destination as an alternative route of the first target travel route, the second target travel route including a road having a speed limit less than or equal to the allowable travel speed as a target travel route of the first vehicle, based on the current position, the destination, and the allowable travel speed,
wherein when the at least one computer cannot generate the second target travel route enabling the first vehicle to reach the destination from the current position, the at least one computer sets a vehicle connection point at which a passenger of the first vehicle transfers to another second vehicle within an area in which the first vehicle can arrive by traveling on a road having a speed limit less than or equal to the allowable travel speed.

2. The travel assistance device according to claim 1, wherein the at least one computer generates the second target travel route in such a way that a ratio of distance traveled by the first vehicle on a road having a speed limit less than or equal to the allowable travel speed is higher when the allowable travel speed is set to a speed lower than the set speed than when the allowable travel speed is not set to a speed lower than the set speed.

3. The travel assistance device according to claim 1, wherein the at least one computer generates the second target travel route in such a way that the first vehicle travels only on a road having a speed limit less than or equal to the allowable travel speed from the current position and reaches the destination.

4. The travel assistance device according to claim 1, wherein the at least one computer generates the second target travel route including a road having a speed limit less than or equal to the allowable travel speed and having a highest speed limit.

5. The travel assistance device according to claim 1, wherein
the at least one computer
acquires information about margin time, the margin time being delay time of an arrival time at the destination tolerated by a passenger of the first vehicle, and
generates a candidate of the alternative route within a range of the margin time.

6. (canceled)

7. The travel assistance device according to claim 6, wherein the at least one computer dispatches an autonomous driving vehicle as the second vehicle.

8. The travel assistance device according to claim 6, wherein
the at least one computer
acquires information about margin time, the margin time being delay time of an arrival time at the destination tolerated by a passenger of the first vehicle, and
selects the second vehicle from among candidates of an autonomous driving vehicle capable of arriving at the destination within a range of the margin time.

9. The travel assistance device according to claim 6, wherein when the set allowable travel speed is less than a threshold value, the at least one computer causes the first vehicle to stop.

10. The travel assistance device according to claim 1, wherein the at least one computer sets the allowable travel speed to a lower speed when no passenger is on board the first vehicle than when a passenger is on board the first vehicle.

11. A travel assistance method for detecting a surrounding environment of a first vehicle by an onboard sensor of the first vehicle and assisting the autonomously traveling first vehicle in traveling, based on the detected surrounding environment, the travel assistance method causing at least one computer to perform processing comprising:
acquiring position information about a current position of the first vehicle;
acquiring position information about a destination of the first vehicle;
generating a first target travel route from the current position to the destination;
setting allowable travel speed, the allowable travel speed being a speed at which the first vehicle can be caused to travel under autonomous driving control, to a speed lower than a legal speed or a set speed, the set speed being a speed set by a user, according to a recognition state of the onboard sensor or a vehicle state of the first vehicle; and
generating a second target travel route from the current position to the destination as an alternative route of the first target travel route, the second target travel route including a road having a speed limit less than or equal to the allowable travel speed as a target travel route of the first vehicle, based on the current position, the destination, and the allowable travel speed,
wherein when the at least one computer cannot generate the second target travel route enabling the first vehicle to reach the destination from the current position, the at least one computer sets a vehicle connection point at which a passenger of the first vehicle transfers to another second vehicle within an area in which the first vehicle can arrive by traveling on a road having a speed limit less than or equal to the allowable travel speed.
